(19) United States
(12) Patent Application Publication
(10) Pub. No.: US 2014/0350973 A1
(43) Pub. Date: Nov. 27, 2014

(54) SYSTEM AND METHOD FOR HEDGING PORTFOLIOS OF VARIABLE ANNUITY LIABILITIES

(71) Applicant: Peter Phillips, Toronto (CA)

(72) Inventor: Peter Phillips, Toronto (CA)

(21) Appl. No.: 14/458,741

(22) Filed: Aug. 13, 2014

Related U.S. Application Data
(62) Division of application No. 11/955,089, filed on Dec. 12, 2007.

(51) Int. Cl. G06Q 40/08

(52) U.S. Cl. CPC G06Q 40/08
USPC 705/4

(57) ABSTRACT

A system and method for managing hedge program liability involving obtaining policyholder information that constitutes the liability portfolio and asset information that constitute the asset portfolio; simulating at least one partial sensitivity and valuation for the liability portfolio for projected market data to obtain valuation simulation data. The system and method then involves using market date information estimating at least one partial sensitivity and valuation of the liability and asset portfolios using the simulated partial sensitivity and the market data. Based on comparing the one estimated partial sensitivity against at least one partial sensitivity limit buying or selling one or more assets to restore the estimated partial sensitivity within the limit if the estimated partial sensitivity breaches the at least one partial sensitivity limit.

### CROSS-REFERENCE TO RELATED APPLICATION

This application is a divisional of U.S. application Ser. No. 11/955,089, filed Dec. 12, 2007, the contents of which are hereby incorporated by reference.

### FIELD OF THE INVENTION

This invention relates to a system and methods for hedging variable annuity product risks. In particular this invention relates to efficiently determining and managing variable annuity hedge program the risks.

### BACKGROUND OF THE INVENTION

Insurance contracts are used by individuals and organizations to manage risks. As people interact and make decisions, they must evaluate risks and make choices. In the face of financially severe but unlikely events, people may make decisions to act in a risk adverse manner to avoid the possibility of such outcomes. Such decisions may negatively affect business activity and the economy when beneficial but risky activities are not undertaken. With insurance, a person can shift risk and may therefore evaluate available options differently. Beneficial but risky activities may be more likely to be taken, positively benefiting business activity and the economy. The availability of insurance policies can therefore benefit those participating in the economy as well as the economy as a whole.

Insurance companies often sell financial guarantees embedded in life insurance products to customers. Generally, the focus is on selling products to people with money who want to plan for their retirement. Many of these products offer customers, the investors or policyholders, investment returns and in addition embed financial guarantees. A simple product of this design is a Guaranteed Minimum Accumulation Benefit, or GMAB, where a policyholder invests money in a mutual fund or similar vehicle and is at least guaranteed to get their principal back after eight years for example regardless of actual fund performance. With a GMAB, the policyholder has the potential upside if markets increase over the eight years, and if the markets have fallen, the policyholder will at least get their money back.

Companies selling these financial guarantees must periodically value and report on the risk of the financial guarantees. In addition, regulatory requirements often require companies to report on their risk exposure and require the companies to have sufficient reserves and capital on hand to support the risk profile associated with the financial guarantees they have sold. Valuing financial guarantees embedded in life insurance products for financial, risk management and regulatory reporting, is a computationally challenging prospect for insurance companies. Companies often use substantial computer power as well as internal and external resources to perform the necessary calculations to value and report on such products like variable annuities, segregated funds or unit linked contracts.

Every time a company, or what is known as a direct writer, sells one of these insurance products it accumulates systemic market risk in its portfolio. Many companies try to compensate for growing systemic risk by establishing hedging programs to transfer the risk back to the market. In general, hedging is an investment that is taken out specifically to reduce or cancel out the risk in another investment.

It is generally complex and costly to hedge variable annuity risks given the complexity of the guarantees and their financial and regulatory reporting requirements. After solving the most basic requirement of how to generate liability cash flows in a timely manner most insurance companies face challenges in running a hedge program for variable annuity risks including: 1) developing a performance attribution framework for the hedging program, 2) developing an intra day Greeks interpolator to help view and manage the risks for the liability in-between overnight valuation runs, and 3) developing a tool to view hedge portfolio assets and the liability risks together in order to manage and monitor the hedge program risks as whole on an intra-day basis as market conditions change. As a result of these challenges, it is difficult, time consuming and expensive to successfully maintain a portfolio with manageable risk. These shortcomings lead to increased costs to consumers as companies charge more for the risk they assume, and the security of the portfolio is less than would be preferred.

Many direct writers struggle with creating a performance attribution framework for variable annuity hedge programs to explain the hedge program performance from one period to the next. Typically insurance companies use sequential analysis to explain the change in hedge program performance from one period to the next. In this approach, the emphasis is on completely explaining an already known change from one period to the next by changing one risk factor or collection of risk factors in the model or system at a time until all the factors have been changed and the final results is obtained. This is generally a capricious approach because the performance attribution results depend on the ordering of the identified risk factor changes. The day over day change can be completely explained using sequential analysis but there are many different ways of explaining this change and there are no fixed rules to consult about either the ordering of risk factors or what constitutes a risk factor or how to combine risk factors together in one step. In addition, it is not clear if the information produced by such a performance attribution system provides the value-added feedback to actually improve hedge program performance in way that traders and hedge program managers can understand.

Many direct writers also struggle with trying to estimate the intra-day values and sensitivities of the risk exposure in a variable annuity hedge program because they cannot calculate this information explicitly on an intra-day basis due to the large runtimes associated with calculating the necessary results for liability. For example, the liability might depend on twenty inputs and as the market opens in the course of the day eighteen of these inputs may change in value, and direct writers are faced with the challenging prospect of re-estimating the liability value and sensitivities to these inputs as market conditions change. There are no known great solutions to this difficult re-estimation problem, which is fundamentally a liability problem. Asset prices can generally be calculated on-the-fly. In contrast, for the liability a traditional approach is to use overnight runs, where hundreds of scenarios are run to calculate the value and sensitivity of the liability at various points, and then use this information as an aid to infer the hedged book sensitivities, such as net delta, rho, gamma and vega, when the market is actually open. However the estimates from the overnight runs are generally difficult to interpolate because of the noise in the results because a Monte Carlo or scenario based valuation method is used and because of the comparatively few sample observations from a liability function with high dimensionality or one with so many inputs. To get around these problems a direct writer may look at only the total account value movements and the long term interest-rate movements and reassess the liability value as well as relevant first and second order sensitivities at a few different levels or a handful of extreme points. However doing so provides the direct writer with only a rough guess of the sensitivity and value of the liability due to capital market changes on an intra day basis because only a very small part of the possible sample space is used.

Variable annuity hedge programs run large overnight batch processes to get the end of day liability valuation information, to feed the performance attribution reporting, and to help estimate the value and risk profile of the liability between overnight runs. To help estimate the value and the risk of the liability on an intra day basis companies may create a two-way table and then calculate the required partial sensitivities at the intersection points of the table for a small set of capital market risk factors. For example, a two-way table could be constructed using total account value changes as a percentage on a first dimension and long term interest rate changes on a second dimension. At each intersection point the overnight runs will be used to calculate the value and all the relevant partial sensitivities. In effect a giant lookup table is created with this approach and a basic interpolation methodology, such as linear interpolation, is deployed to estimate the change in value and the Greeks of the liability, or risk factor sensitivities, as market conditions change during the day. At this point companies typically use linear interpolation or cubic splines to obtain estimates between actual data points used to create the table. Such techniques do not smooth out the noise resulting from the Monte Carlo simulations, and some produce spurious jumps in estimated results. In addition, most techniques can only reliably handle two dimensional estimation problems.

Many direct writers also struggle with an important operational concern in running a variable annuity hedging program: creating a system to pull all the liability and hedge portfolio information together which presents information on the overall hedge program's net risk exposure and profit and loss on an intra-day basis, updating as capital markets change throughout the day. Such a tool should incorporate live market prices, and provide an update of the asset positions value and sensitivities, and provide an update of the liability's value and sensitivities, in order to manage and monitor the overall net risk exposures effectively. Generally companies have detailed information on the liability in one system, and detailed back office information on the hedge portfolio's assets in another system making it a challenge to collect, store and access information for the hedging program.

Direct writers are typically skilled at building and maintaining large databases or building and maintaining a company web site, but they are not skilled at creating complex tools that pull in information from different systems, and combining information with live market based pricing feeds. Because of these difficulties, many variable annuity hedging programs just rebalance and monitor risk exposures based on overnight runs and use rules of thumb to manage and monitor the risk on an intra day basis.

There is a need for a system and method that combines the liability and asset information in one place, to reflect the appropriate values and net sensitivity figures in a timely and accurate manner using live market prices, to have automatic risk limit monitoring and messaging, and to have indicative rebalancing trade sizes in such a hedge program system or tool.

### BRIEF DESCRIPTION OF THE DRAWINGS

In drawings which illustrate by way of example only a preferred embodiment of the invention,

FIG. 1 shows the economic performance attribution aspects of an embodiment of the invention;

FIG. 2 shows the derivation of the estimator by expanding the valuation formula of the performance attribution aspect of an embodiment of the invention;

FIGS. 3A, 3B and 3C show an example of the application of the performance attribution aspect of an embodiment of the invention;

FIG. 4 shows the kernel estimator of the estimator aspect of an embodiment of the invention;

FIGS. 5A and 5B show an example of the application of the estimator aspect of an embodiment of the invention;

FIG. 6 shows two plots from an example of the estimator aspect of an embodiment of the invention;

FIG. 7 shows the parts of the monitoring aspect of an embodiment of the invention;

FIG. 8 shows the inputs that may be used in relation to the monitoring aspect of an embodiment of the invention;

FIGS. 9A and 9B show an example of the application of the real time monitoring aspect of an embodiment of the invention.

FIG. 10 is a schematic representation of an apparatus for implementing an embodiment of the invention.

### DETAILED DESCRIPTION OF THE INVENTION

### Performance Attribution

The economic performance attribution model in the first aspect of the preferred embodiment of the invention uses mathematics to jointly explain the change in value in the overall net position of the hedge program from one time period to the next. To do this, a variable annuity is treated as a derivative security, and using stochastic calculus as well as economic and financial principals, mathematical formulae are developed to jointly estimate the change in value of the liability, and the asset, and then the overall net position from one period to the next. By construction this approach will have a small unexplained or “other” bucket but nevertheless be highly efficient and unbiased in a statistical sense. As used here, unbiased meaning that if one has two vectors, one being the actual change, and the other being the estimated change, the sample correlation statistic should be close to one and the intercept from linear regression should not be significantly different than zero. The mathematical formulae will explain a large portion of the change in value of the liability over a short interval of time, such as a business day, while the necessary asset calculations can be performed exactly because closed form solutions exist for their value, thereby permitting and providing an economically sound and quick explanation for hedge program performance over time.

In the preferred embodiment, the hedge program is viewed as a portfolio of derivative securities. Since formulation and valuation of derivative securities are widely known, the behaviour of the hedge program portfolio can be calculated using stochastic calculus and economic theory. A mathematical expansion for the change in value of the system, ignoring higher-order terms, can predict what happens to the value of the system as time passes and the relevant risk factors change according to the implemented valuation models used in the program. The relevant risk factors depend on the liability valuation model and may include the passage of time, the underlying account value, interest rates and market volatility for equity returns and interest rate changes. The mathematical relationships can be used to show how much the system will change, given information about the initial first and second order sensitivities of the system to risk factors changes, and given information about the actual changes in the risk factor levels over a short period of time like a business day. This framework can by construction identify the marginal contribution of each risk factor to the overall change in the hedge program results, and explain the overall change in joint manner, in an economically sound manner subject to a small residual piece missing due to the higher order terms in the expansion.

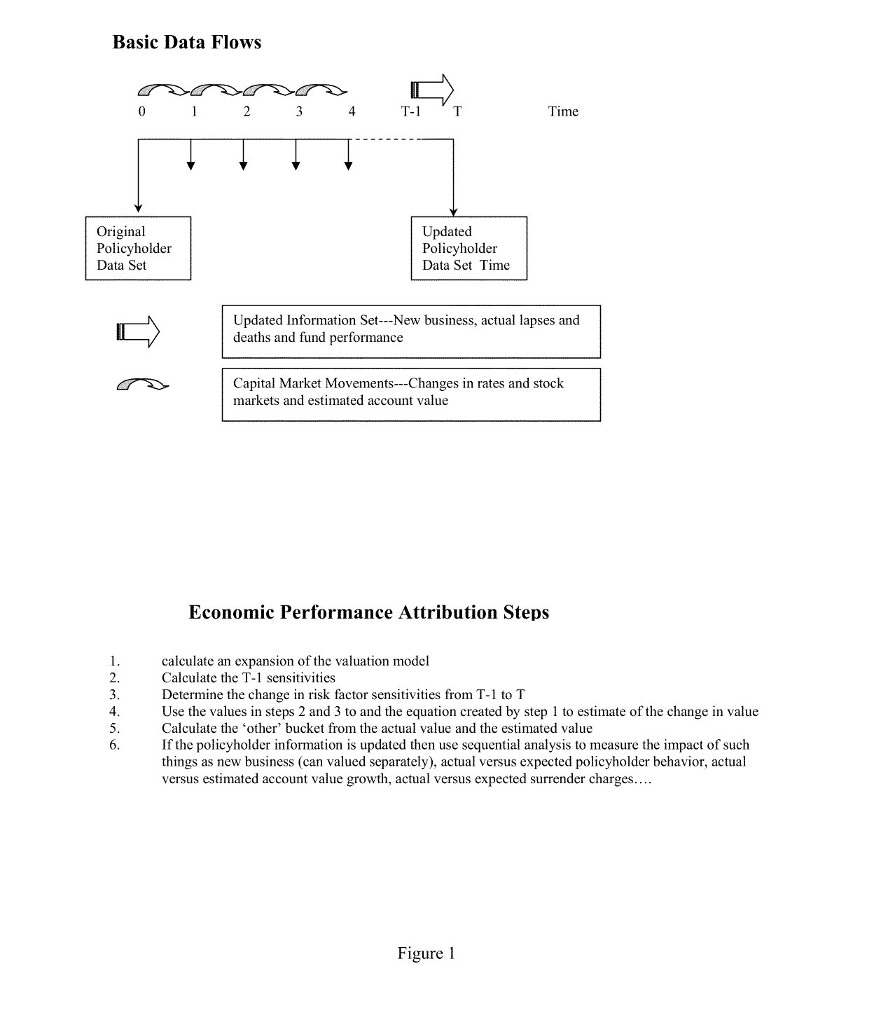

In order to better understand the concepts behind the performance attribution framework of the preferred embodiment, FIG. 1 consists of three parts: a basic data flow section, a decision tree section, and a section showing a list of the steps in the preferred embodiment. Attention will be focused on calculating the liability, as the assets, as previously discussed, are generally easily calculated using widely known closed form solutions, transparent market prices, and market based inputs for the relevant valuation formulae.

In the basic data flow section of FIG. 1 there is a timeline from time zero to time T with an arbitrary number of intervals in the intervening period. For example, in this case, time zero could be the start of the month and time T the end of the month and intervals could be business days.

The policyholder data set is what drives the liability cash flow model. The policyholder dataset is typically generated on a monthly basis. During a month a company will try to update the account value of individual policyholders to reflect changes in market levels since the last update, or alternatively estimate the change in a policyholder's account value either by using market changes of widely followed market indices as a proxy or by using the actual net asset values of the underlying funds as proxy. Either way, a new policyholder data file is effectively created at the end of each business day containing the new estimated account value and these in turn are used in the overnight runs to calculate the value and the sensitivities of the liability every day.

In the absence of a new or updated policyholder data set arriving in the system, the economic performance attribution model takes the change in the capital market factors over the time period in question, for example one day, and uses the initial sensitivities that were calculated in the overnight run from the previous night, to derive the estimated systematic change in the liability using the mathematical expression or expansion.

On the other hand, if a new policyholder data file is generated and is added to the system, for example at the end of a month, then the economic performance attribution framework follows the same steps described above but then sequential analysis is completed to estimate the marginal impact of the new information in the policyholder data file, like new business arriving, and to reflect any unexpected changes in existing policyholder information due to lapse, mortality, withdrawal, and actual fund performance. For example, if new policyholders are omitted from the first calculation, then are calculated on their own sequentially and the impact could be labelled as ‘new business’ in the economic performance attribution model.

If no new or updated policyholder information arrives, then the economic expansion or mathematical expression is used to calculate the estimated change in the liability and to solve for the ‘other’ bucket. The overall change in the value of the liability and assets is already known because of the over night valuation runs on the liability. On the other hand if a new policyholder data set arrives, showing people have lapsed, died, or joined on as new business, one uses the economic expansion followed by sequential analysis to isolate the dollar impact due to things like unexpected changes policyholder behaviour due to lapses, mortality and withdrawal, and unexpected changes in the account value due to differences between actual fund values versus estimated fund values, and finally the impact due to new business sales or volumes arriving during the month.

For example, when new policyholder information arrives, a first step is to continue to use the policies the original policyholder data file with the estimated account values rolled forward to reflect changes in the stock market level since the last update. Then sequential analysis is used to isolate the value of the new business arriving by using only the new additions to the policyholder data file and re-running the valuation process. Sequential analysis can be used again to measure the impact of unexpected changes in policyholder behaviour, a grab bag that measures the unexpected changes in all the other policyholder information like lapses, mortality, withdrawals and bonuses by creating yet another phantom policyholder dataset with old policies and another with actual account values and the old policies updated with the latest information, and subtracting the valuation differences and labelling it unexpected changes in policyholder behaviour.

The ordering of these sequential steps is an implementation decision but each step in the sequential analysis a phantom data set is created, and a new line item in the performance attribution report is needed which will have non-zero values on days where new information arrives, and the sum of the steps must take the policyholder data set from old or original data set to the new or final policyholder data set.

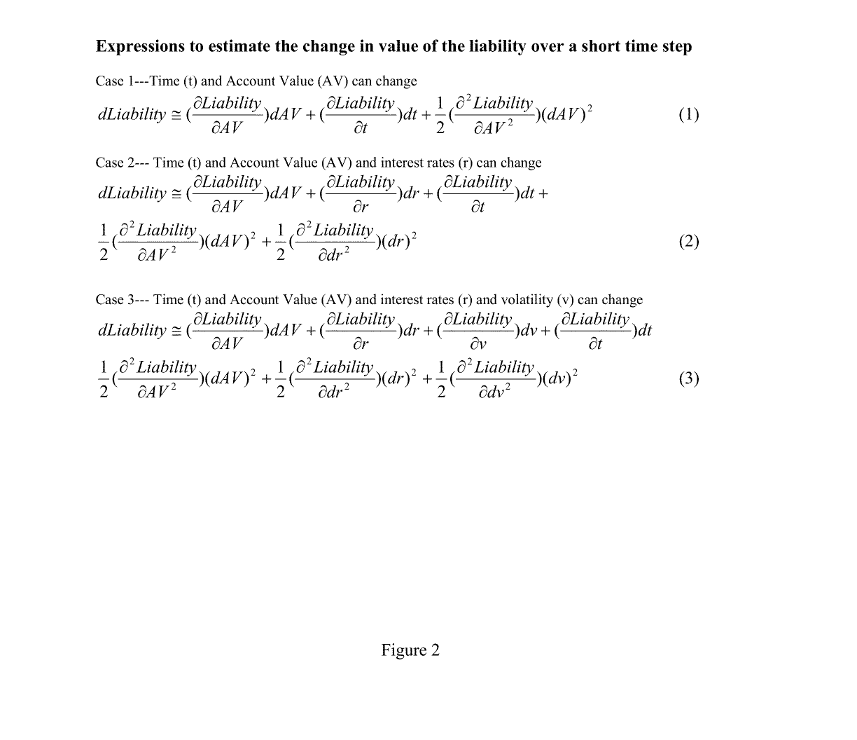

The second section of FIG. 1 lists the steps of the preferred embodiment of the economic performance attribution model. Step one of the method is to derive the appropriate expansion or mathematical expression to estimate the change in value of the liability. This step is more fully described below in relation to FIG. 2. The expansion will depend on the model the direct writer uses in the hedge program to value the liability. For example, a company may use a valuation model with just a stochastic account value process and a fixed scalar for interest rates. In another example, a company may use stochastic account value and interest rate processes in the valuation model.

Even amongst similar classes of valuation models a different mathematical expression may be used because of implementation differences. For example, a company may use one long term interest rate or a company may use 10 points to represent the whole term structure of interest rates. An appropriate expansion has to be created for the different valuation model implementations. In the preferred embodiment, a Taylor Series expansion is used but other mathematical expansions may be used instead, which may provide for improved convergence properties. The most appropriate expansion depends on the valuation model being used. Simplifications can generally be made by substituting underlying stochastic processes of the valuation model back in to the expansion.

In step two of the process indicated in the second section of FIG. 1, the partial sensitivities are calculated based on an expansion from the first step. In FIG. 2 there are expansions for different kinds of liability valuation models. Equation (1) relates to models where time changes and the account value is stochastic. Equation (2) relates to models where time changes, and the account value and interest rates are stochastic and equation (3) relates to models where time changes, and the account value, interest rates, and the volatility of equity returns are stochastic. For example, in equation (2) a direct writer needs to calculate five sensitivities: the first derivative of the liability with respect to a change in the account value, the first derivative of the liability with respect to a change in interest rates, the first derivative of the liability with respect to a change in time, the second derivative of the liability with respect to a change in the account value and the second derivative of the liability with respect to a change in interest rates. Calculate in this sense means to estimate via simulation. A common method to do this is by changing one factor at a time holding everything else constant or alternatively by moving a factor up and down holding everything constants and taking the average rate of change as a measure of the first derivative and using the sample results and a central difference approach to estimate the second derivative. These estimated or calculated sensitivities are then combined with the relevant changes in underlying risk factors which may include time, the account value and interest rates, to produce an estimated change in the liability over one time period.

Higher order and cross greek terms have been ignored in the expansions shown in Equations (1), (2) and (3) in FIG. 2. The terms for interest rate, r, and the volatility, v, can be scalars or vector values.

FIG. 2 also includes how the various Taylor Series expansions can be extended to assets in the hedge portfolio, and how the underlying stochastic processes for the account value, interest rates and volatility can be substituted back into the Taylor Series expansions to more directly calculate the hedge program's hedging error over a single time step. Furthermore FIG. 2 includes how changes in the account value, and changes in interest rates and volatility, can mapped back drawings from the underlying stochastic processes for the risk factors to provide feedback on the magnitude of actual changes in underlying risk factors versus modelling assumptions for these risk factors.

Terms may be added to the Taylor Series expansion, and the dynamics of the underlying account value may be substituted back in to the expansions to simplify the expansion and map real world risk factor changes to risk neutral liability price changes. For example, standard geometric Brownian motion of the account value may be substituted into equation (1) and to produce an expression for hedging error over one time step. It may be shown that such an expression is chi-squared. In this setting, account value returns can be mapped back to a standard normal distribution in the diffusion process for the underlying stochastic account value movement.

Using the equation (1), the hedging error, H, for a writer of options may be simplified to the following equation which shows that the hedging error is proportional to the gamma

$$( \frac{{\partial }^{2} Liability}{\partial {AV}^{2}} )$$

of a portfolio, the time increment (Δt), the square of the account value (AV²), the volatility of the account return (σ²), and the standard normal distribution (ε) assuming the portfolio has no delta risk. Since the standard normal distribution is squared in the below equation, H is chi-squared. If the drawing is less than one standard deviation, the hedging error is positive, larger than one standard deviation the hedging error is negative, and when equal to one standard deviation the hedging error is zero.

$$H = - \frac{1}{2} \frac{{\partial }^{2} Liability}{\partial {AV}^{2}} {AV}^{2} {σ}^{2} ( {ɛ}^{2} - 1 ) Δ t + O ( Δ {t}^{\frac{3}{2}} )$$

The economic performance attribution model is a linearly separable model. This means the approach works in exactly the same way for hedge portfolio assets as it does for the liability. Asset values and sensitivities and risk factor changes can be directly substituted into the Taylor series expansions to produce relevant figures. No detailed asset valuation calculations are presented in FIG. 2 because widely available closed form solutions are available for standard hedge portfolio securities like stock index futures, and options, and swaps. In contrast to the liability these securities have widely available and known formulae that produce exact values and relevant ‘Greeks’ in fractions of a second versus the days, weeks or months it may take for the liability on a single computer to calculate.

In step three indicated in the second section of FIG. 1, the changes in the risk factors over the period in question are determined by using close of business day values for relevant risk factors. The period is usually from one business day to the next. Examples of changes in the risk factors include changes in the 30 year interest rate levels and changes in the relevant stock index market levels that drive the liability valuation processes.

In step four, the partial sensitivities determined in step 2 are combined with the changes in risk factors determined in step 3 according to the appropriate expansion found in step 1. The expansion produces an estimate of the total change in value of the liability from one time period to the next. The same method is used for assets in the hedge program but for very primitive derivative securities like stock index futures where the change over a time period is explained by the first derivative with respect to the stock index multiplied by the change in value of the stock index future the other parts of the expansion can be ignored in practice. With options however most parts of the expansion will be used and this allows the performance of this asset to be partitioned properly, into properties like delta, rho and vega risk and matched off against the liability in such a way to provide clearer picture of economic performance attribution.

Step five involves solving for the ‘other’ bucket for the liability and solving for ‘other’ bucket on the asset side if complex securities like stock index options are used inside the variable annuity hedging program. The ‘other’ bucket is a placeholder for higher order terms. The ‘other’ bucket is calculated by explicitly subtracting the estimated total change in value of the liability calculated in step 4 from the actual change in the value of the liability from the overnight runs.

As described earlier, step six involves incorporating new policyholder information.

In the first aspect of the preferred embodiment of the invention, the economic performance attribution has three significant aspects. First is the presence of an ‘other’ bucket in the performance attribution report. As described earlier, the other bucket is a direct result of using an expansion to estimate the change in the value of derivative security over a short period of time, which includes the liability and the assets in the hedge portfolio. Other performance attribution models rely on sequential analysis approach to perfectly and completely explain the change in value in the hedge program from one day to the next. Secondly, the preferred process needs a valuation model specific expansion to estimate the change in value of the liability. Sequential performance attribution models are valuation model agnostic and will work as long as all the factors or groups of factors are exhaustively changed one at a time. A third aspect of the preferred attribution method is the need to estimate the partial sensitivities. The preferred economic performance attribution model requires the initial partial sensitivities of all the important capital market risk factors be estimated and the change value of these risk factors over the time period in question be measured. Sequential analysis does not explicitly require the calculation of these partial sensitivities but instead follow a series of arbitrary ordering of intermediate calculations to produce a final result.

The following is an example of the economic performance attribution model as applied to a simple liability. First the major assumptions being made in this worked example are presented. Second, the model will be applied to a single time interval without the arrival of any new policyholder data. Lastly, the example will include the application of the model to a single time interval accompanied by the arrival of new policyholder data.

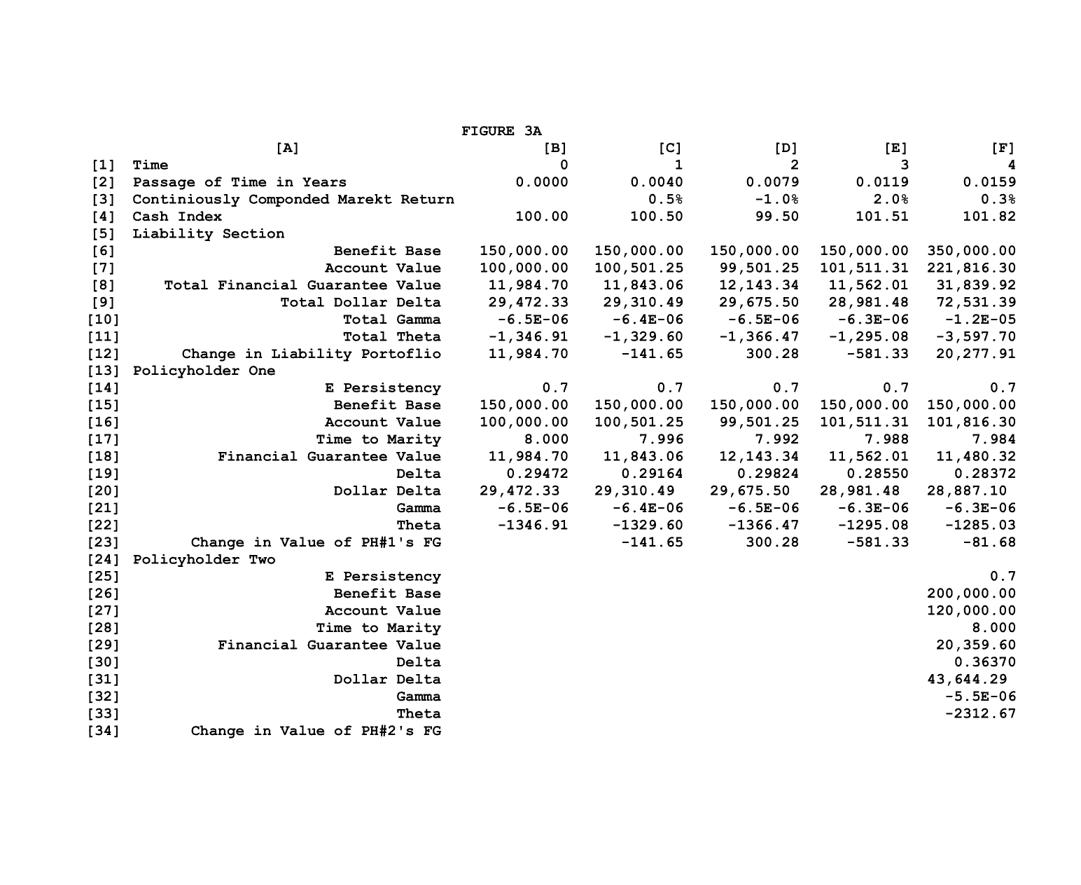

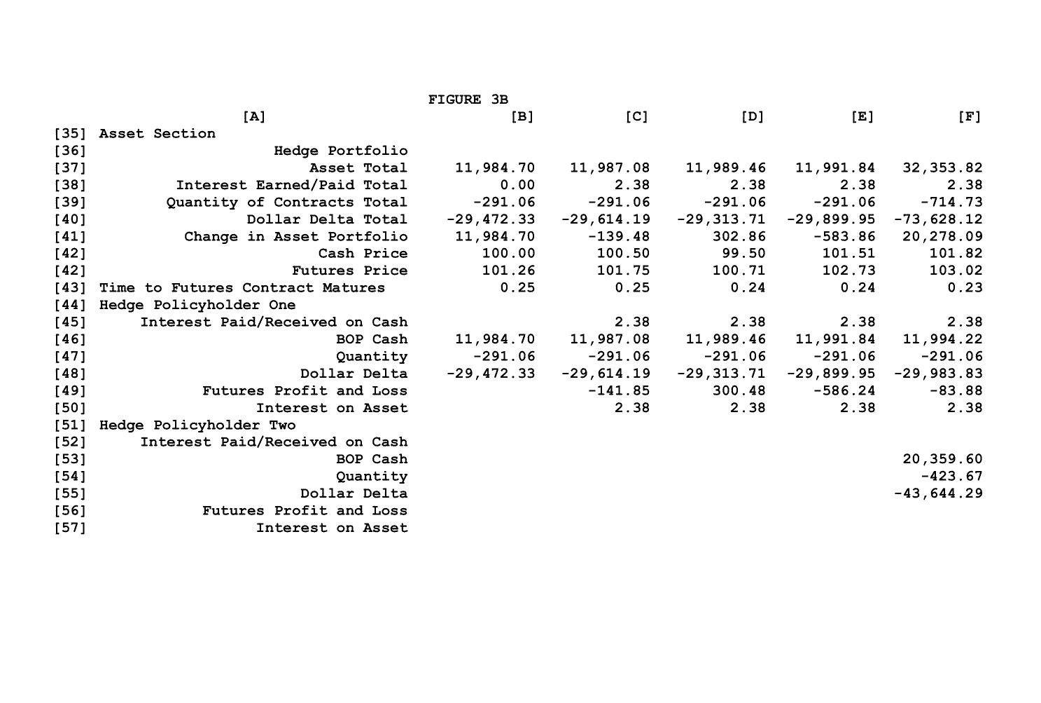

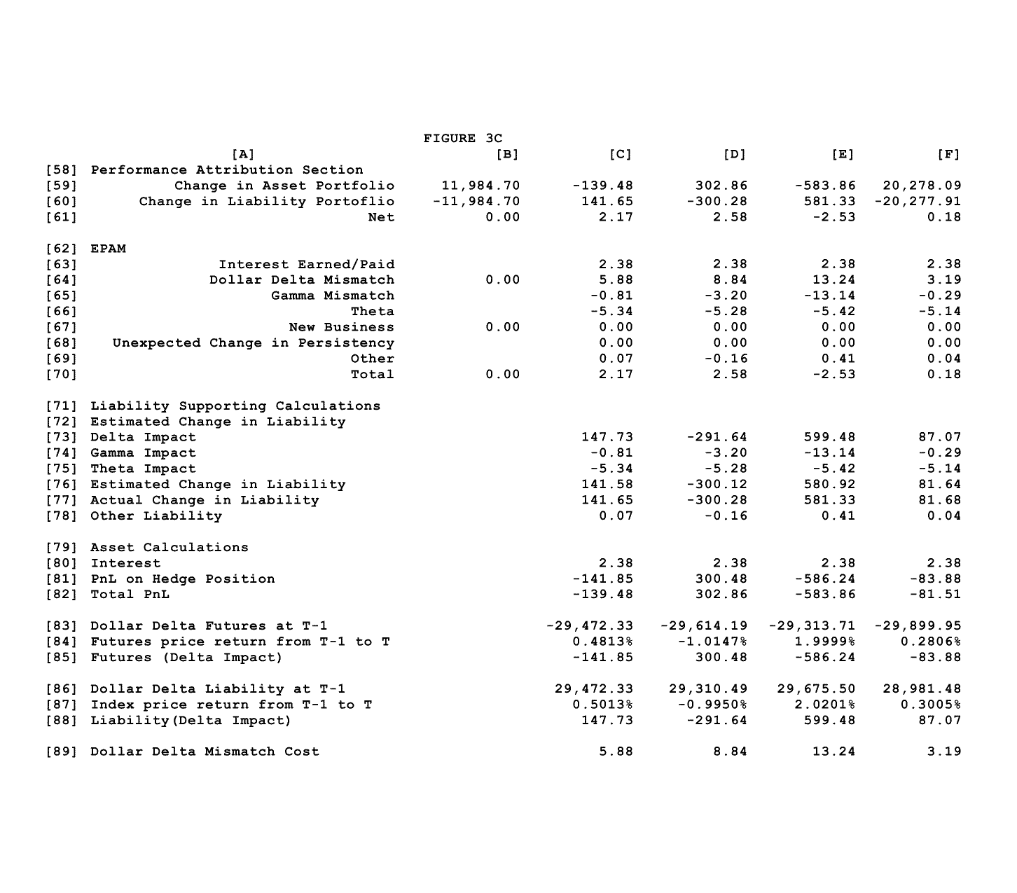

FIGS. 3A, 3B and 3C include an example application of the performance attribution model as described above. The table directly below includes several assumptions that will be used in the worked example in FIGS. 3A, 3B and 3C.

| Givens | |
|---|---|
| Financial Guarantee | Pt * Max(Benefit Base − Account Value, 0) |
| Interest Rate | 5% |
| Volatility | 15% |
| dt | 0.003968254 |
| dividend rate | 0% |
| Contract Maturity at Issue | 8.00 |
| Futures Contract Maturity | 0.25 |

In the table above, in the first line the liability's payoff is described as a put option, given the maximum of zero or the difference between the Benefit base, which is know at time zero, and the Account Value, which is known at expiration of the contract in 8 years, and with Pt being the time zero estimated terminal persistency representing the number of put options embedded in the single policyholder's financial guarantee at maturity of the contract. Other capital market assumptions used in the example are presented further below in the table and include the following: a prevailing interest rate of 5%, a market volatility figure of 15%, a one business day or 1/252 of year time step represented as ‘dt’, a dividend rate of 0%, and an underlying futures contract with a maturity of three months at time zero. As would be understood, these assumptions are being made for the purpose of the example and are not limitations imposed by the model.

In this example the liability as a whole is the sum of individual liabilities each of which are represented as simple put options. The hedge program is in this example is established at time zero by selling stock index futures and the position is only adjusted after the arrival of a second policyholder. So the performance attribution worked example will first explain the performance of a hedge program for a single policyholder over several business days, and then examine the impact associated with the arrival of a new second policyholder and then finally explain and treat the case of an unexpected change in the estimated terminal persistency estimate of the first policyholder.

In the table in FIGS. 3A, 3B and 3C, there are five columns, starting with the letter A and ending with the letter F, and 89 numbered rows. Information is arranged into three areas, the liability area in rows 6-34, the hedge portfolio area in rows 35-57 and the economic performance attribution area in rows 58-89.

The liability area includes rows 6-34, and specifically includes, at rows 6-12, the liability at summary level, at rows 13-23, the specific details for the first policyholder and, at rows 24-34, the specific details for the second policyholder.

The asset area includes rows 35-57, and specifically includes, at rows 35-43, the summary level hedge portfolio information, at rows 44-50, the details on the hedge for policyholder number one and, at rows 51-57, the details on the hedge for policyholder number two.

The performance attribution area includes rows 58-89 and specifically includes, summary level net performance information, at rows 62-70, sources of the net performance figures, at rows 79-82, hedge portfolio sources of profit and loss, at rows 83-85, profit and loss on the futures contracts due to delta risks, at rows 86-87, profit and loss on the liability due to delta risks, at row 89, the overall net profit and loss for the hedge program due to delta risks. Please note in rows 84 and 87 simple return figures are used to estimate the impact related to delta movements, which in this case is the initial dollar delta multiplied by the return as per the Taylor series expansion. The detailed breakdown of the sources of performance, are found in rows 71-90. Rows 1-4 reflect the passage of time from when policyholder 1 was issued and account value returns.

At the top of the liability section is the total guaranteed amount or benefit base, the total account value, the total dollar delta, the total gamma and the total theta for the liability as well as a line for changes in the total liability value. Regarding the first policyholder, FIGS. 3A, 3B and 3C include the expected persistency, the benefit base, the guaranteed amount, the account value, and the time to product maturity, the financial guarantee value, the delta, the dollar delta, the gamma, the theta and finally the change in value of the financial guarantee for policyholder number one. Typically these values would be produced by the overnight runs but in this example the value of the financial guarantee is calculated using a Black-Scholes formula multiplied by the persistency estimate. As mentioned earlier, it is assumed that there is an interest rate of 5%, a volatility of 15%, a time to maturity of 8 years, a dividend rate of zero, and a strike price given by the guaranteed amount and the underlying is the account value. As time passes and the account value moves the sensitivities and values of the financial guarantee change for policyholder one, and this can be seen in row 18 where it starts at $11,984.70 and becomes $11,480.32 by period four. At time zero the financial guarantee is issued with zero profit, the value of the guarantee is $11,984.70 and is offset exactly by single premium of $11,984.70 paid by the policyholder one at time zero so there is no change in value to report at this step. This zero value idea is repeated again in period four for the second policyholder.

In the asset section, summary information, at rows 35 to 43, includes total cash, total interest earned or paid over the period, the quantity of futures contracts held in the hedge portfolio, the total dollar delta, the change in value for the total asset portfolio, the underlying cash index price for the futures contract, the corresponding futures price, and the time to maturity for the futures contract. In rows 44-50 and 51-57 a more detailed breakdown of information on the first and second policyholders can be found respectively.

In rows 46 and following can be found, the beginning of period (BOP) cash, the quantity of futures contracts sold short, and the dollar delta associated with the short futures contracts, which is equal to the futures price times the number of contracts sold short. Beginning in the second time period (column C), at row 49, is the change in value associated with the hedge portfolio for the first policyholder. Since the hedge is not adjusted and is a short position, the hedge portfolio loses money when the market goes up and gains money when the market goes down. Row 50 includes the interest earned on the cash asset since a single premium at time zero was collected, and interest may be earned or paid on subsequent cash flows derived from the profit and loss on the futures contracts which settle at the end of every period. This hedge portfolio consists of cash and a short position in futures contracts and in the example, the futures contracts have zero value when they are put on or initiated and only spin-off losses or gains from one period to the next. In the example, a hedge portfolio is created for the second policyholder in period four and profit and loss occurs for this hedge in period five.

The performance attribution section in FIGS. 3A, 3B and 3C, starts at row 58 and ends in row 70, with the supporting calculations to estimate the change in the liability in rows 71 to 78, and the hedge portfolio profitability in rows 79 to 80, and the delta contribution to the change in value of the hedge portfolio in rows 83 to 85, and the delta contribution to the change in value of the liability in rows 86 to 88, and finally a net delta contribution or delta mismatch figure for the hedge program as whole. The high level performance figures are presented in rows 58 to 61. The net performance figure in row 61 is reconciled in rows 63 to 70. In the example, at row 70 in column C a figure of $2.17 is presented as the net change, based on hedge portfolio losing $139.48 and the liability portfolio gaining $141.65. Using the economic performance attribution model, the $2.17 gain is explained in part by the interest gain of $2.38, a delta mismatch gain of $5.88, a gamma loss of $0.81, theta loss of $5.34 and an ‘other’ bucket, or unexplained gain, or an unreconciled movement of the liability from time period zero to time period one of $0.07. This $0.07 is calculated by subtracting the estimated change in liability in row 76 from the actual change in liability in row 77. The estimated change in the liability is found using the expansion. Row 79 to 90 shows how the dollar delta mismatch figures are calculated, and shows the delta gain in the liability from the market movement and then subtracts this gain from the delta loss on the futures contract showing an overall net result of a net gain of $5.88 for delta exposure over the first time period.

In row 69 the ‘other’ bucket changes in each time period but is small and changes sign in the worked example which is exactly what is expected because the ‘other’ bucket in the economic performance attribution approach has an expected value of zero and should not grow over time.

In this example, the gamma mismatch numbers are negative because the hedge program is involves selling a put option. As expected, according to option valuation theory, the size of the gamma mismatch over a time step is proportional to the square of the account value change as is seen in the second term of the expansion. The theta mismatch, or time decay, is negative in the example but it will change sign over time as the time decay starts to work in favour of the option writer.

The hedging mismatch or overall net hedge program performance, in row 61, should in expectation be zero but is generally positive if the account value does not move very much and negative if there is a large movement in the account value over a time short time step. For the initial time periods, there are two zero entries, one labelled ‘new business’ in row 67, and the other labelled ‘unexpected changes in persistency’. The ‘new business’ row has zero values because of the assumption that the financial guarantees are sold at cost. If the financial guarantee was sold for a profit then a one time positive unexpected change would be recorded in the ‘new business’ entry, and it follows that row 61, the net change in the portfolio would also contain the marginal benefit or profit associated with issuance or sale new business. On the other hand, if the financial guarantee was sold for a loss, the sign would be reversed in both sections.

The unexpected change in persistency in row 68 contains the change in value associated with unexpected change in the persistency of the liability portfolio. In this example, the persistency estimate does not change, as is indicated the constant values across all time periods in row 14 of FIG. 3. If there was a change in the persistency, however, it would affect the value of the financial guarantee in an endogenous way. In this model persistency of the liabilities is analogous to the number of options. In this example, since the persistency did not change over time there was no unexpected change in persistency in row 68.

As further example, the change in values based on a change in persistency can be calculated as follows. For this purpose, the persistency estimate for the first policyholder is changed from 0.7, as was used in FIGS. 3A, 3B and 3C, to 0.6 in the final period. The summary economic attribution data from period 4 using a persistency estimate of 0.7 is found in the last column of FIGS. 3A, 3B and 3C.

| EPAM | |
|---|---|
| Interest Earned/Paid | +2.38 |
| Dollar Delta Mismatch | +3.19 |
| Gamma Mismatch | −0.29 |
| Theta | −5.14 |
| New Business | 0.00 |
| Unexpected Change in Persistency | 0.00 |
| Other | 0.00 |
| Total | +0.18 |

In this example according to the valuation model the financial guarantee value is the product of the number of options and the value of a single option. Because the persistency is analogous to the number of options, the value of a single option can be determined. Then using the value of a single option and the new persistency estimate, the new financial guarantee value is calculated and the difference between the financial guarantee with and without the change can be determined.

As applied to this example for the first policyholder at time period 4,
Financial Guarantee Value: $11,480.32
Persistency: 0.7
Effective value of one put option: $11,480.32/0.7=$16,400.46
New Financial Guarantee Value: $16,400.46×0.6=$9,940.28
Unexpected change in value due to change in persistency: $1,640.05

In this example, the profit and loss impact of the unexpected change in persistency is +$1,640.05 because the liability suddenly shrunk and this figure would show up in separate line item in the economic performance attribution table. In FIG. 3, the change in persistency would be indicated in row 68 column F. The net change in the portfolio would also be affected by $1,640.05 (row 61 column F in FIG. 3) would have an entry of $1,640.23. The change in the liability entry (row 60) would be reduced by the unexpected gain in persistency of $1,640.05. Typically, the persistency is updated once a month but some direct writers try and update all the policyholder information every business day. Either way this type of sequential analysis can be done to report on unexpected changes policyholder behaviour due to mortality, lapsation and withdrawal, grouped together or done separately, once the appropriate sequencing or chronology of stepwise changes is laid out in the sequential analysis.

One advantage of the economic performance attribution of the invention is that it provides an unambiguous model of performance attribution. In the preferred embodiment of the model the valuation model implemented by the insurance company to value the liability in the hedging program is tied directly to the economic performance attribution process because it requires an appropriate liability expansion be developed and used in the estimation process. This means the economic performance attribution model is inextricably linked to how a company actually models the liability risk in practice. If a company uses a sequential modelling approach of performance attribution the results are capricious and can change based on the ordering of the risk factors, or due to the grouping of two or more risk factors together in one step of the sequential analysis. Using a sequential modelling approach to performance attribution two insurance companies with exactly the same valuation model and exactly the same policyholder data can arrive at two different explanations about the hedge program performance based on the ordering or grouping of risk factors in the sequential analysis implementation. In contrast the economic performance attribution model will provide one unambiguous result because it explains the change in value in a joint manner.

The economic performance attribution model may also acts as an internal control mechanism for the hedging program by providing evidence that the liability valuation model is functioning properly. Day in and day out the change in the liability's value must be estimated and that means the initial sensitivities must be calculated properly and the change in the value of the risk factors must be captured properly otherwise the ‘other’ bucket in the hedge program will be huge or grow over time. Even one bad figure can produce odd results which mean the model and data collection process must all be working properly for the economic performance attribution figures to make sense in the first place. Sequential performance attribution analysis typically explains the change in value perfectly regardless of whether there is a problem in the liability model or an input parameter, or in the calculation of a Greek used daily in a hedge program.

The economic performance attribution model can also provide feedback to the hedge program managers in way they can understand and act on. Terms such as delta, gamma, vega, and rho are familiar ones to hedge program managers and traders who control the net risk exposure for the book or portfolio by buying or selling derivative contracts. The economic performance attribution model isolates the shadow cost associated with running each net Greek exposure as a opposed to sequential analysis attribution model which may not map hedge program performance back into these option price sensitivities or explain performance in terms traders can understand and modify in light of performance and experience.

The economic performance attribution model is also a flexible model of performance attribution because it may be used with a variety of different liability valuation models by generating different stochastic calculate expansions. Once a liability valuation model has been selected and implemented an appropriate stochastic expansion can then be derived to estimate the change in liability's value from one time period to the next. For example, one direct writer might use a live long term interest rate and account value movements and scalar inputs for volatility in their liability valuation model. Another direct writer may choose to use several points to describe the term structure of interest rates which will change every day. Under the economic performance attribution model a different expansion will be generated to handle the interest rate risk in each valuation model. A direct writer may also chose to ignore higher order terms or to explicitly calculate the cross correlation terms and other high order terms in attempt to improve the efficiency of the estimator for the change in the liability.

The economic performance attribution model can also be modified with respect to how an insurance company may wish to perform the sequential analysis to handle the arrival of new information like a basis change to the valuation model itself, where a parameter like the mortality rate is suddenly changed, or the arrival on new business, or to reflect unexpected changes in lapse, mortality, withdrawals or fund performance versus modelled estimates. Extra buckets or attribution headings can be used to identify specific information of interest. For example, the marginal value associated with new policyholder behaviour information on existing business could be grouped into just one bucket. Or alternatively a direct writer may wish to have more granularity around unexpected changes in policyholder behaviour on existing business by looking at lapse, mortality and withdrawal and actual fund performance separately. In this circumstance a direct writer may create a sequential ordering or model of how to disentangle policyholder behaviour. For example the direct writer may first compare actual withdrawals from expected, and then actual lapses versus expected and then finally mortality versus expected. Once done the direct writer has traversed all the policyholder data from the old data set on existing policyholders to the new data set on existing policyholders. Such flexibility of the model allows a direct writer to tailor the performance attribution reporting to better suit their needs and issues.

The economic performance attribution model may also be applied to other complex insurance based hedging programs or alternatively to complex insurance based naked risks outside of variable annuities. For example, the model can be used instead of sequential analysis for popular insurance products that have financial guarantees embedded in them, like fixed annuities, single premium deferred annuities, and equity indexed annuities. The economic performance attribution model can also be applied to other complex derivative products and hedging programs that are not insurance product based including path dependent fixed income and equity derivative risks found in residential mortgages, CDS's or credit default swaps, CDOs or credit default obligations, and interest rate swaptions. The economic performance attribution model can be used to help explain changes in value at risk, capital at risk, and earnings at risk numbers form one quarter to the next because of its expediency and accuracy.

### Greek Estimator

In a second aspect of the invention, an efficient unbiased Greeks estimator is used to estimate the intraday values and Greeks of the liability in a variable annuity hedging program in timely and accurate fashion.

The technique is highly efficient and unbiased in a statistical sense, and its calculations can be done on-the-fly. In the Greeks estimator, statistical routines are used to estimate the value and sensitivities of the financial guarantees embedded in variable annuities, typically referred to as the liability in the hedge program, as the market changes on an intraday basis. The asset or hedge portfolio GreeksGreeks, which are based typically on futures and stock index options and interest rate swaps, are by comparison generally straightforward to calculate, and generally have known available closed form solutions. In practice, the necessary calculations for the asset or hedge portfolio are done in fractions of a second.

The Greeks estimator follows several steps to obtain the intra-day estimates for the Greeks and the value of the liability portfolio. First, information is obtained from the overnight liability valuation runs and is used as an input to feed, depending on the direct writer's implementation, either a single or a series of nonparametric regressions. A modelled relationship between the desired output value and input value(s) is determined by the direct writer's implementation considerations and decisions. For example, a direct writer may decide to just use one nonparametric regression to estimate the value of the liability and then differentiate that expression directly with respect to risk factors to produce all the relevant greek information. On the other hand a direct writer may decide instead to set up a series of nonparametric regressions and therefore use a series of input values. Factors effecting this decision to either use one data set or a series of data sets include the run times associated with the overnight valuation runs due to the number of risk factors in the implemented valuation run, and if all or only some of the liability Greeks will be monitored on an intra day basis, and other standard run time issues like the number of simulations to be run, the number of cash flow time steps to use, and the number and speed of the computers to use. Either way relevant information is taken from the overnight runs where the value and Greeks of the liability are evaluated under various scenarios. These data may be organized in a flat file or data set to feed the nonparametric regression.

Once this step is completed and when the market is open, estimates of sensitivity and value of the liability are calculated by combining the latest market information along with the data set from the overnight run in the Greeks estimator. As an example, the liability's value may depend on two inputs according to the implemented efficient unbiased Greeks estimator model and in this case include the current account value, and the current interest rate level. In the overnight runs, many simulations are run with using different interest rates and market levels, some with the markets going up, other with the markets down, and some with both markets moving in different directions to develop a sense of how the value of the liability will change when the value of these two inputs change. This information is then fed to the Greeks estimator the next day and is used to estimate the value and sensitivity of the liability as interest rate and stock market levels change during the day when markets are open. Such data sets for the nonparametric regressions may be based on daily or weekly overnight runs.

The efficient unbiased Greeks estimator performs multidimensional interpolations on the samples generated by the overnight runs. The overnight runs on variable annuity liability valuation are typically performed using Monte Carlo simulation. Monte Carlo simulation valuation techniques produce estimated, rather than perfect valuation results, and as such a confidence interval exists for results. The efficient and unbiased Greeks estimator filters out the noise associated with the scenario process and is a multidimensional non-linear interpolation tool that is generally quick enough to allow the estimator to be used with live market data in a real time setting.

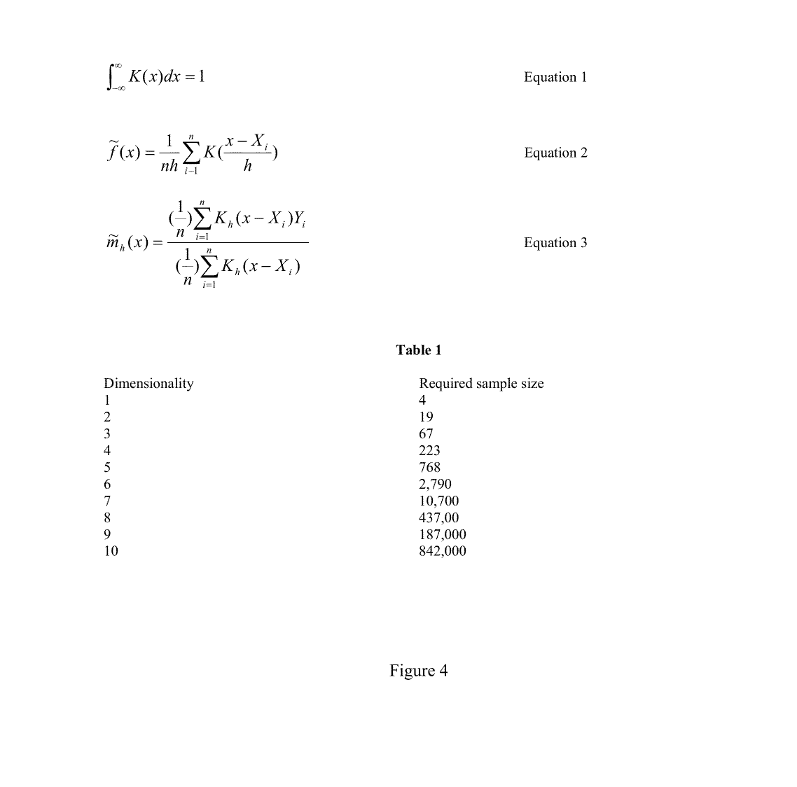

FIG. 4 includes some details on kernel estimation and kernel regression. Kernel estimation is a technique that uses sample observations to estimate the underlying continuous probability density function. Equation 1 in FIG. 4 is a general kernel function, K, which satisfies the condition that the integral over all possible outcomes, from negative infinity to positive infinity, is one. Typically, a symmetrical probability density function, such as a normal density function or Gaussian kernel is used as the kernel function. Other kernel functions may be used such as epanechnikov, biweight, triangular and rectangular. The ‘h’ in the figure represents the window width and its value depends on what probability density function is used. A kernel estimate is the sum of symmetric probability distributions with the mean being an observation and h being the sample standard deviation if a normal density function is selected.

Equation 2 in FIG. 4 is a univariate kernel estimator applied to kernel K, and having n observations and a window width or smoothing or bandwidth parameter of h. In the preferred embodiment, the smoothing parameter h is calculated as 1.06 multiplied by the standard deviation of the sample and the number of data points in the sample to the power of −⅕. Equation 3 in FIG. 4 is a univariate kernel regression equation, specifically known as the Nadararya-Watson estimator. Although not shown in FIG. 4, multivariate analogues exist for equations 2 and 3 for situations involving more than one dimension. The number of dimensions used in the regression equation will depend on the number of variables, or inputs, the direct writer uses to estimate the partial sensitivities and liability valuation in the efficient unbiased Greeks estimator.

Table 1 in FIGS. 3A, 3B and 3C includes data on the relationship between the accuracy of the resulting estimation, the number of samples and the number of dimensions being simulated. In this case the table shows the number of simulations required for a given dimensionality to ensure that the relative mean square error at zero or E{\hat{f}(0)−f(0)}²/f(0)² is less than 0.1 given the optimal window width for multivariate normal distribution and a normal kernel. This table gives the sample size required to achieve this objective as a function of dimension. The more dimensions used in the overnight runs, the more simulations are required for the same degree of accuracy in the answers. For example, to estimate the value of a financial guarantee with equity market movements and interest rates movements, 67 observations are required to get a relative mean square error at zero of less than 0.1 assuming all samples are drawn from a standard multivariate normal distribution.

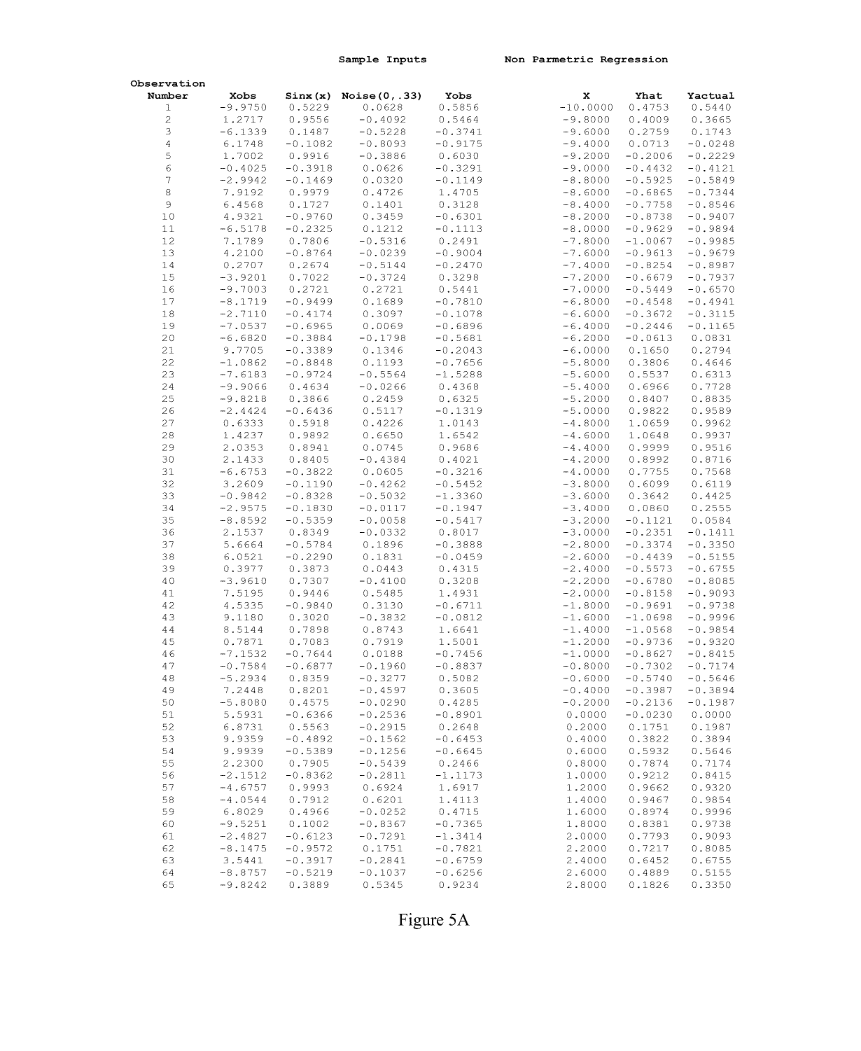

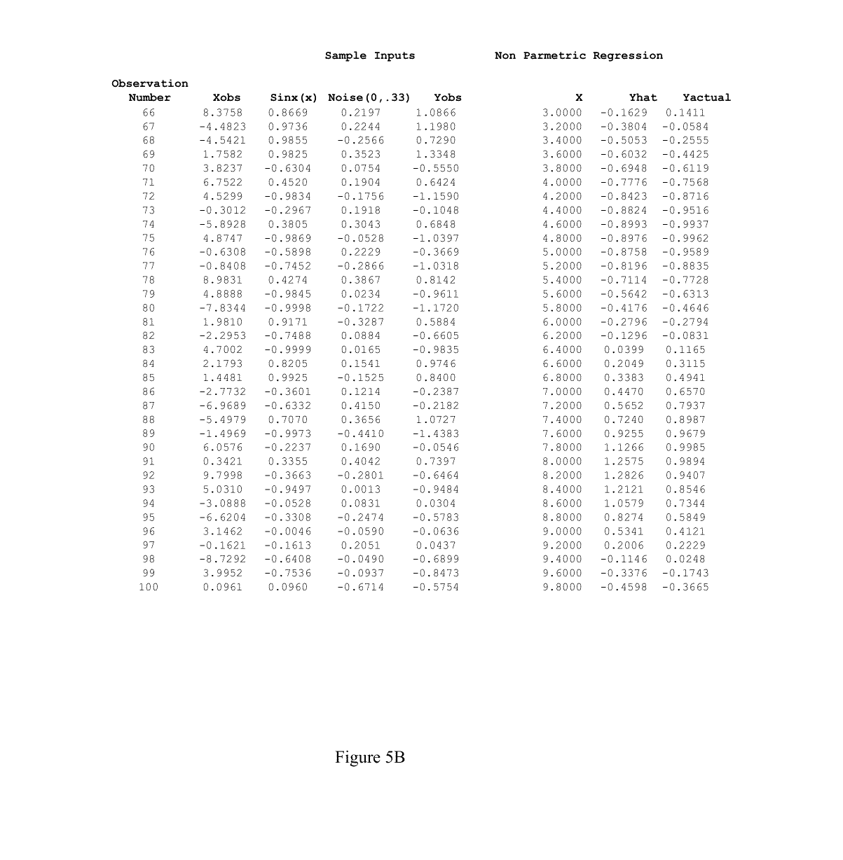

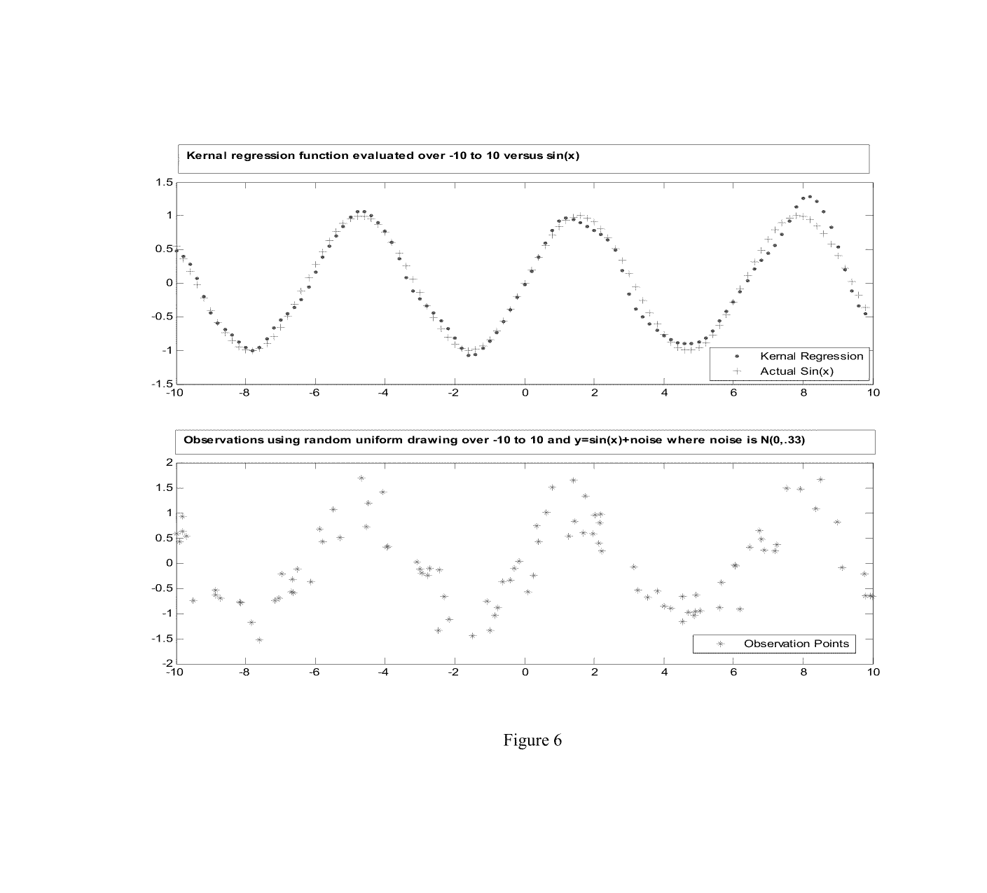

A simple example of efficient unbiased Greeks estimator follows and is presented in FIGS. 5A and 5B showing its ability to filter through sample noise and its ability to interpolate. In this case, in FIGS. 5A and 5B, we start with a hundred observations, found by taking a uniform random samples over the number range of negative 10 to positive 10 to represent the x-coordinates in the observation set, and then using the function sin(x) function plus random samples drawn from a normal distribution with mean of zero and the standard deviation of 0.3, for the y coordinates. This creates a two-dimensional sample data set with a true underlying function of y=sin(x). In an actual application, the underlying function would not be known. In the table in FIGS. 5A and 5B, a hundred observations are presented and are labelled Xobs and Yobs respectively, and the table also contains the estimated and actual function over the range of negative 10 to positive 10 where Yhat is the estimated result versus the actual or true result labelled Yactual. The smoothing parameter used in this example, as referred to above, is found in this case to be equal 0.4103. FIG. 6 contains two plots, the lower one showing the observations and the upper one showing the estimated function versus the actual function.

The efficient unbiased Greeks estimator process will produce a continuous function. A kernel estimator can also be developed for each risk factor separately to help estimate a particular sensitivity of value. Similarly, a user could evaluate the estimator for the value of the liability, and directly differentiate the resulting estimator function to produce all the other estimated sensitivities.

The procedure for the Greeks estimator can be used to estimate in a variety of different settings to estimate a variety of values including value at risk calculations, earning at risk calculations, and capital at risk calculations, or as an all purpose tool to quickly re-estimate the impact of changing capital market risk factors or inputs on the risk profile of the company as a whole. Using such an estimator avoids re-running typically time consuming simulations for path dependent multidimensional risks such as complex derivative securities, credit derivatives, mortgages, swaptions, fixed annuities, single premium deferred annuities.

### Risk Management System

In another aspect of the invention, the real time risk management system collects real time market information, partial sensitivities and valuations for the hedge program in a single presentation. Collecting the information assists with managing the variable annuity hedge program risks and with hedge program risk limit monitoring. The information preferably collected includes information on the liability, information on the assets in the hedge portfolio, as well as live market prices for relevant risk factors that are changing throughout the day, like the stock market levels and interest rates. The presented information includes updated estimate of the profit and loss for the hedge program as a whole and all the relevant and appropriate net risk exposures like delta and rho. Sources of the live market data may come from either Reuters or Bloomberg or another data provider. Hedge portfolio positions may also be maintained in a database that can be queried intra day to reflect changes in the portfolio as trades are made during the day.

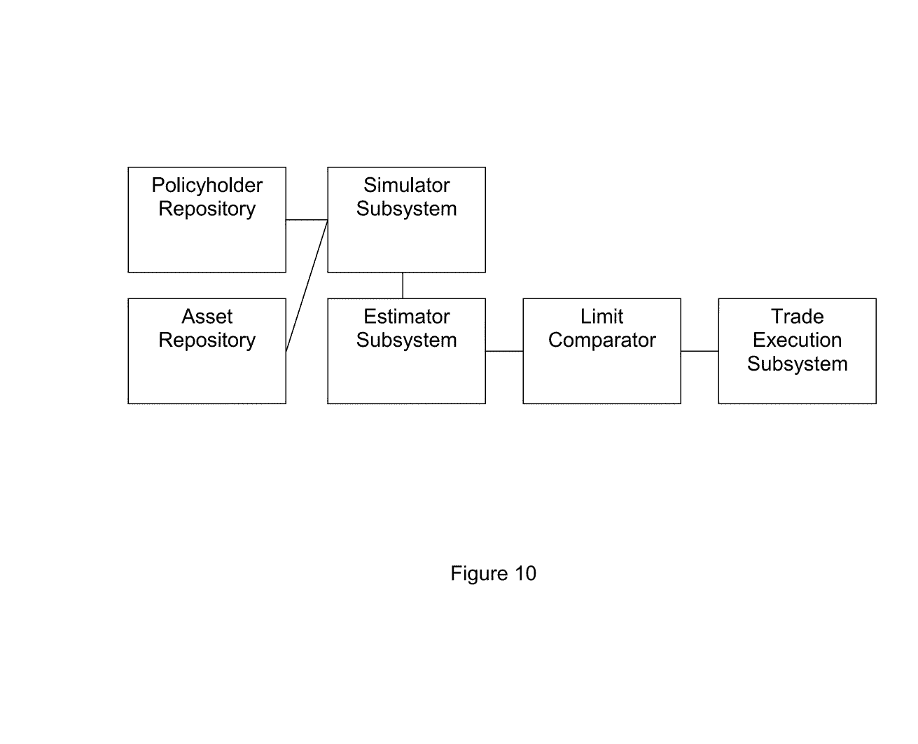

FIG. 10 is a schematic of an apparatus implementing an embodiment of the invention. The apparatus includes repositories, such as databases, for the policyholder and asset information. The simulator subsystem uses the policyholder and asset information to perform the overnight runs. When the markets are open, the estimator subsystem using real time data from the markets and the output from the simulator subsystem to provide estimated partial sensitivities and valuation results. The estimator may use closed form solutions for asset valuations and sensitivities. The limit comparator compares the sensitivities to limits imposed by the portfolio managers and if those limits are breached, may provide information to the trade execution subsystem to perform trades to bring the portfolio back within the limits.

The system may use numerical approximations such as the efficient unbiased Greeks estimator referred to above to estimate the liability's value and sensitivities, and use close form solutions to estimate the asset's value and sensitivities in the hedge portfolio. As well, automated limit monitoring may be used with an embedded messaging system to indicate to managers when important risk limits have been breached. Preferably the system is highly automated. Risk exposure information and levels for risk factors may also be stored in a database on intra day basis to help diagnose problems and to improve or refine hedge program performance in the future. The databases that perform these basic operations are collectively known as the hedge reporting database and are typically highly automated and secure repository where information is stored and retrieved by the real time risk management system with the appropriate segregation of duties between the middle, front and back offices.

The real time risk management system presents the hedge program's risk exposure and monitors risk limits in real time. By combining information about the liability from overnight runs, and using something like the efficient unbiased Greeks estimator to estimate the value and sensitivity of the liability to the current market risk factors, and by using closed form solutions to obtain the value and sensitivity of the assets in the hedge portfolio, the system can present an overall representation of the net value and risk sensitivities of the hedge program.

The system may also indicate, in real time, how many derivative contracts may be purchased or sold to cancel out a given risk factor. For example, a hedge program may have a $100 million delta risk limit imposed by risk management at the company. If the net exposure statistic is positive the hedge program is effectively net long the stock market and will benefit if the stock market rallies and conversely if the statistic is negative be short the market and suffer is the stock market rallies. If the stock market rallies the liability's delta will grow smaller and a hedge program will have to buy back futures contracts it has shorted to bring the delta position back into equilibrium. Operationally, a dollar delta limit is typically an absolute value limit which means the hedge program can run a positive or negative net delta exposure but the moment the portfolio goes beyond the limit the system may send automatic messages to appropriate parties informing them what risk limit was broken how many futures contracts need to be bought or sold to make the position flat. In some cases, a direct writer may choose to have the system automatically trigger the necessary buying or selling of contracts to via an electronic trading platform.

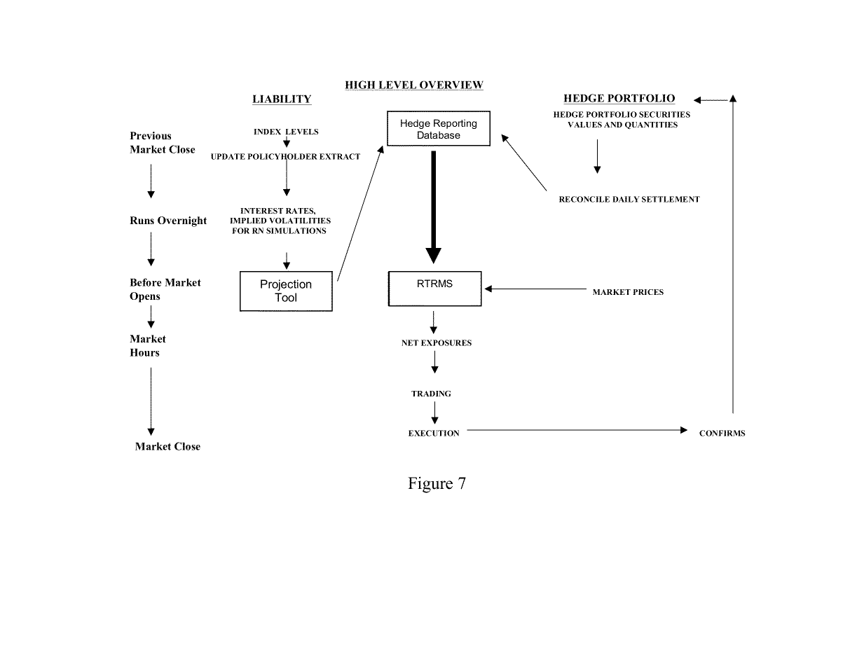

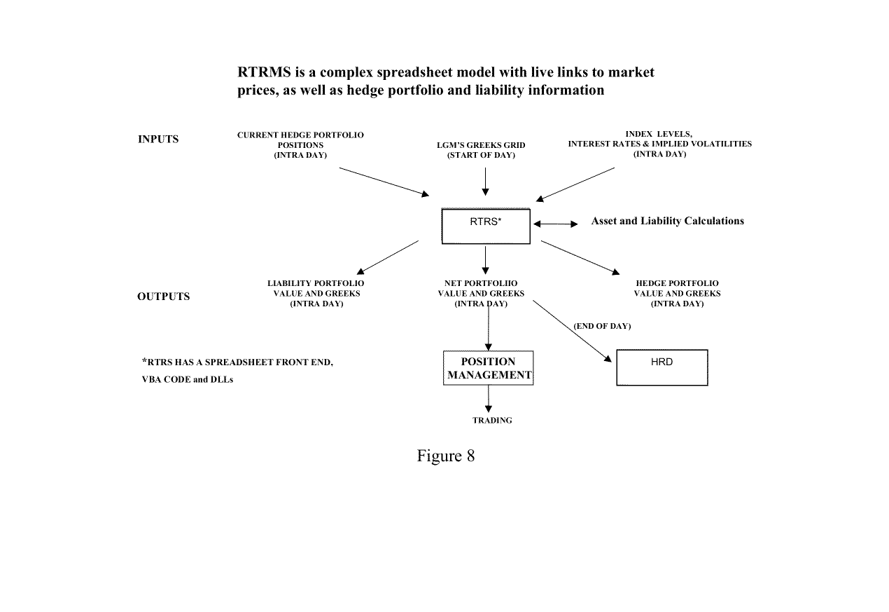

In FIG. 7 there is a high level overview of the monitoring system and how it may operate during the course of a day. FIG. 8 shows inputs and outputs that may be used in relation to a monitoring system.

In the high-level overview diagram of FIG. 7, a simplified timeline from the previous market close to the end of day close of the market is presented. This timeline shows the typical events that happen in the life of a variable annuity hedging program. The first step is to gather information from the previous day's market close, such as interest rate and stock market levels, in order to help construct the valuation scenarios for that day and to help with other valuation processes that run overnight. The overnight runs generate a number of outputs including: the previous end of day value for the hedge program, performance attribution figures, and information about the liability to help assess its value and risk due to market changes until the next day's calculations can be performed. This sensitivity information is reviewed before the market opens, and is used to feed the intra-day re-estimation process, like the Greeks estimator for the liability's value and sensitivity. The asset portfolio's value and sensitivity may be calculated on-the-fly using simple formula and relevant market inputs.

During normal market hours changes in a risk factor, such as an interest rate or a stock market index level, cause the liability's value and sensitivities to be re-estimated on-the-fly using a tool such as the Greeks estimator, and the asset portfolio's value and sensitivities to be directly re-calculated, producing a net value and sensitivity profile for the overall hedge program. Monitoring of any limits also takes place in the background, and rebalancing trades may occur throughout the day. Trades are reflected inside of the Real Time Risk Management System to ensure the fidelity of the limit monitoring process. The system may automatically store estimated sensitivities and values in to the database to be used to improve the hedging program in the future and fix any problems that may occur in the system. As well the real time risk management system may use a on-the-fly model like the economic performance attribution system to show in real time the sources of gain and loss on the hedge program as markets move.

FIG. 8 indicates some of the inputs and outputs that may be associated with the risk management system of the invention. For example, inputs to the system will include the current hedge portfolio positions, a Greeks grid or liability sensitivity information to feed the intra day liability estimation process, and intraday market information on all the relevant capital market risk factors like interest rates and stock market levels. With these inputs, and real time asset and liability calculations, an overall net position and the net risk sensitivities for the hedge program as a whole are presented to users of the system. The position management team or trader will use this information as tool to help rebalance a risk. A real-time risk limit monitoring occurs silently in the background and if risk limits are violated the system will automatically send messages to appropriate parties.

The real time risk management system is best suited to life insurance products containing capital market risks, large data sets, complex scenario based valuation routines and long run times. For example a portfolio of variable annuities depends on policyholders' age, sex, and purchase anniversary date, so large detailed records must be kept to accurately value the block of products. These products typically do not have a closed form solutions, so scenario based valuation and estimators are used to update the value and the relevant sensitivities or Greeks of the liability as capital market risk factors change throughout the day. In the section below there are four equations that will help us walk through a worked example of the variable annuity real time risk management system as it applies to delta risks in a variable annuity hedge program that we will review shortly.

(1) Liability Delta for policyholder i at time t

DL_{—}i_{—}t(Account Value_{—}i_{—}t,Interest_Rate_{—}i_{—}t,Dividend Rate_{—}i,Time to maturity_{—}i,Volality_{—}i,Strike_{—}i,Sex_{—}i,Age_{—}i, . . . )

(2) Liability Delta for all policyholders at time t

DL_port_{—}t=DL_{—}i_{—}t for i=1,2, . . . n

(3) Dollar Delta of the Liability at time t during the day

$_{—}DL_port_{—}t=Account Value_{—}i_{—}t*DL_{—}i_{—}t for i=1,2, . . . n

(4) Dollar Delta of the Hedge Portfolio at time t during the day

$_{—}DA_{—}por_{—}t=Q_{—}t*Futures_price_{—}t

The first equation above is a simple one showing how the liability delta for a single policyholder depends on a lot of information, and this means that a database must be used to hold all the information, because all of it is required to produce a mark or value for the book or portfolio. For example, an individual's account value will change from one day to the next, and so will interest rate levels, and so possibly will other variables which are used to estimate the delta of the liability for single policyholder. The second equation shows that the liability delta is really to sum of the individual policyholders' deltas and a database is used to sum individual policyholder output from the valuation engine to produce relevant summary statistics for each individual run. So overnight, the valuation engine completes a large batch job, running hundreds or thousands of scenarios and then collects and stores information to help estimate the end of day value and GreeksGreeks for the liability, and to produce relevant perform attribution number for the performance attribution reports, and to provide a dataset to help estimate the intra-day value and sensitivities for the liability as capital market conditions change. The fourth equation presupposes a complex algorithm or technique is available in the real time risk management system to infer the delta of the liability during normal market hours when markets move because it would take far too long to calculate the liability figures intra-day by brute force. Equation 3 represents the concept of a dollar delta. This is the product of the prevailing account value multiplied by current delta estimate or the first derivative of the liability with respect to a change in the account value multiplied by the account value itself Equation 3 is what needs to be constantly re-estimated for the liability in practice inside the real time risk management system spreadsheet. This can be achieved via a dll (a dynamic link library), or by using software such as Matlab to do calculations in the background, or by creating an executable called by Excel, as the spreadsheet updates with market information. Equation 3 also tells us that the spreadsheet has to have market information coming into it such as swap rates, government bond yields, cash index values, stock-index future prices. Typically a DDE (dynamic data exchange) feed from a Bloomberg or Reuters provides this market information. As these market levels change the spreadsheet recalculates and effectively re-estimates the net risk exposures and overall profit and loss figures for the hedge program and thereby supporting real time autonomous limit monitoring efforts inside of the real time risk management system. Equation 4 represents the hedge portfolio or the assets and in this particular case is equal to the quantity of future contracts held multiplied by the current futures price. Like the liability values the asset figures can be calculated using a formula inside of Microsoft Excel or using an external program such as a Visual Basic for Applications routine, DLL or Matlab. The difference between equations three and four, like a lot of other information in the spreadsheet, is updating every moment of the day during normal market hours. Using cash inferred pricing for the futures contracts also allows the risk to be seen during overnight markets in Asia and in Europe where the futures contracts are still trading as the cash index price, which drives the liability value and sensitivity estimation process, can be inferred by using the fair value estimates from Bloomberg or Reuters for the stock index futures contracts. For example if the fair value spread is +2 and the futures prices is 98 at night this allows an estimate for the synthetic cash index to be 100 and now the liability can be re-estimated. This may be done because the cash equity markets are typically open only from 9:30 am to 4:00 pm while the futures trade around the clock except for on weekends.

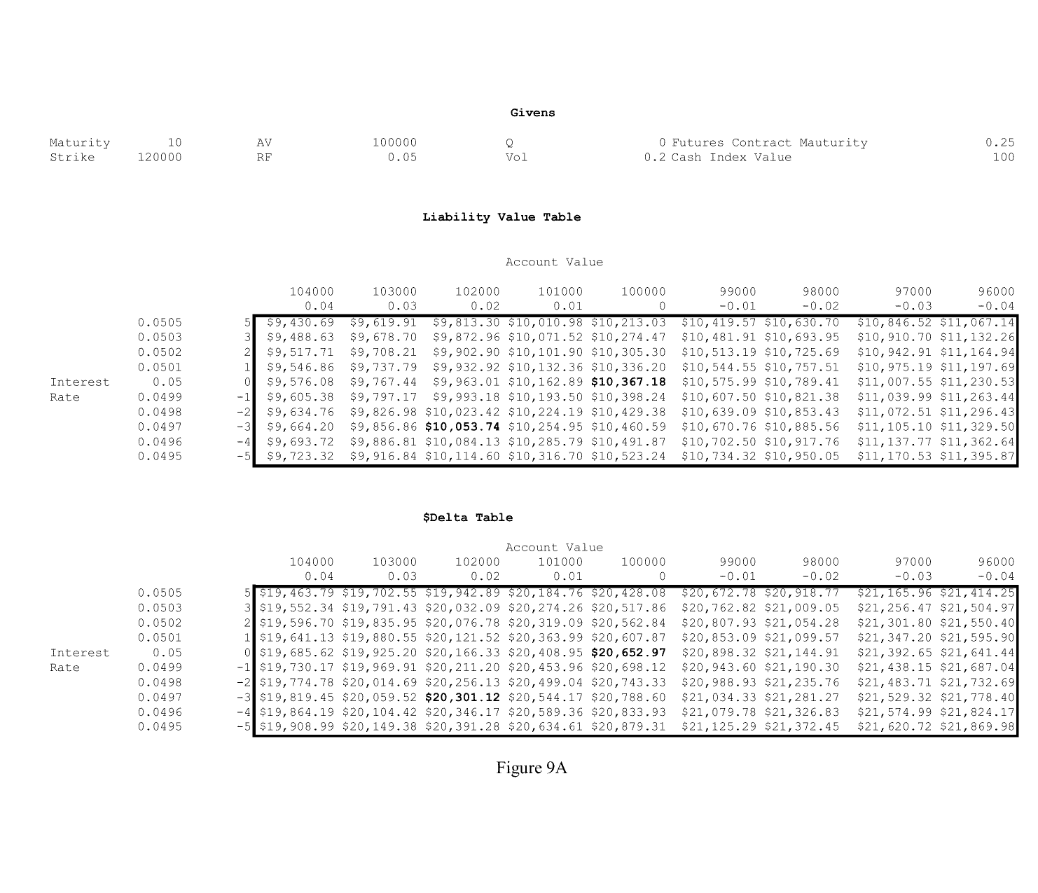

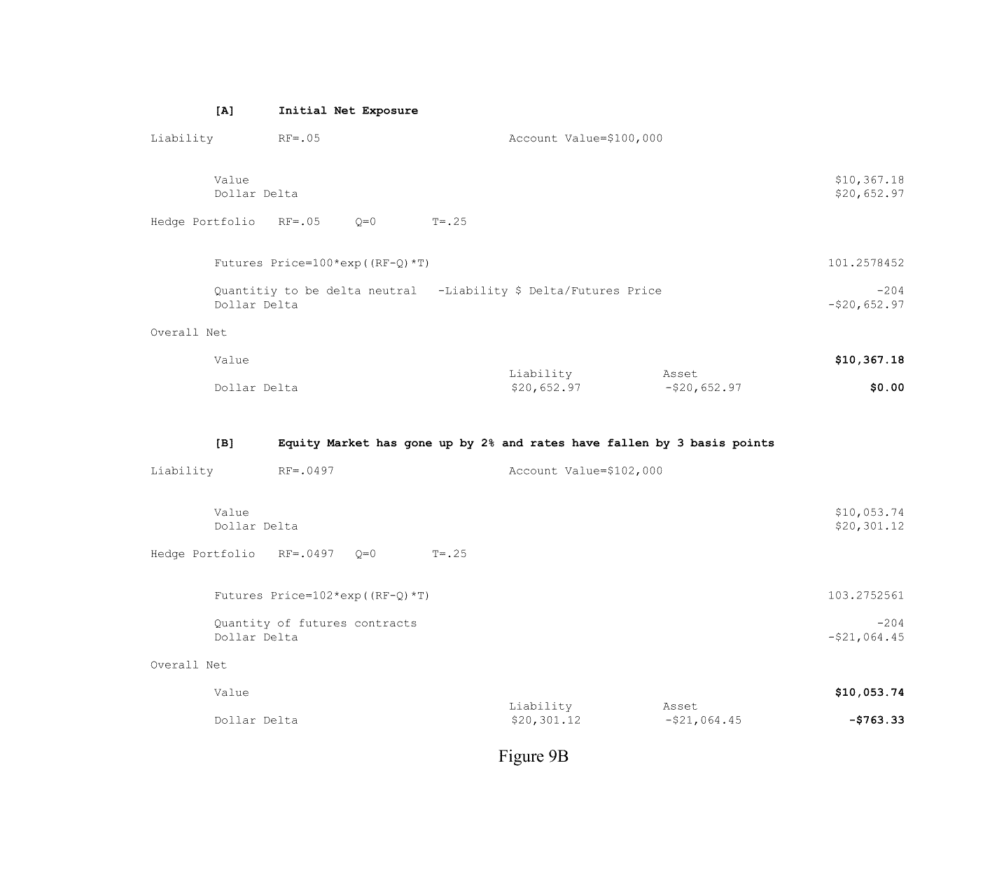

The example in FIGS. 9A and 9B focuses on a single delta risk exposure. Typically, the variable annuity guarantees are a basket option, which means their payoff is determined by summing multiple investment accounts together and involves monitoring and hedging multiple delta exposures. In addition, there may be other sensitivities to consider inside of a variable annuity hedging program, like rho, where a series of key rates or maturities have interest rate risk figures to monitor and to hedge. The real time risk management system can monitor each of capital market risk exposures inside a variable annuity hedging program and provide messaging in the event that pre-established limits have been breached. For example the real time risk management system can provide a net dollar delta statistic throughout the day allowing the hedge program manager to see how close he or she is to a limit. Typically limits are tiered in structure, so that at the first level the hedge program manager is forced to rebalance while at a second limit the CIO or CFO is notified of a serious breach in operations, and a third limit involves notifications to the board of the organization of a grave breach in operations. Aside from continuously monitoring the hedge program limits the real time risk system sends detailed e-mails out in event a risk limit is breached including what needs to be done to zero out the risk in terms of contract names and rebalancing quantities.

In the real time risk management example in FIG. 9 three sections are presented. The first section details the givens that are used to value the liability. In this example the value and delta of the liability can be retrieved by using the Black-Scholes equation, while the dollar delta of the futures contract comes from the price of a futures contract multiplied by the quantity of futures contracts held. The next section presents two lookup tables to find the value of the liability and its dollar delta for various interest rate and stock market levels. The third section includes a presentation of the mechanics of determining the initial value and dollar delta exposure and then what happens to those as the account value and interest rate change. In the first area assumption information is presented to initially value the liability and the futures contract. In the second section, two tables are presented that show how the value of the liability and the dollar delta of the liability change as account values and interest rate levels change. We can see by inspection that the initial value is $10,367.18 and initial dollar delta is $20,652.97 according to the two tables. The tables also show the liability's value at $10,053.74 and the liability's dollar delta is $20,301.12 when the market moves up by 2% and interest rates fall by three basis points and a net dollar delta exposure of −$763.33. Below are the calculations for the initial net exposure for the book, broken down by liability and by hedge portfolio. And the section also highlights what happens when the equity markets climb by 2% and rates fall by three basis points.

The real time risk management system can be tailored to individual variable annuity hedging programs and but can also find appropriate application outside of variable annuity hedging programs including managing other complex path dependent risks where valuation runtimes are a serious burden like with mortgage portfolios, credit derivative portfolios, path dependent equity derivative portfolios, equity indexed annuities.

Various embodiments of the present invention having been thus described in detail by way of example, it will be apparent to those skilled in the art that variations and modifications may be made without departing from the invention.

I claim:

1. A method for attributing a change in liability valuation for a hedge program to one or more risk factors associated with a valuation model for the hedge program comprising the steps of:
calculating by a computing system, a mathematical expansion of the valuation model associated with the hedge program for each risk factors associated with the valuation model;
calculating by the computing system one or more partial sensitivities of the mathematical expansion to the valuation model;
allocating the change in liability valuation to the one or more partial sensitivities by applying the changes in risk factors to the partial sensitivities;
calculating by the computing system the estimated change in liability valuation using the partial sensitivities and the changes in risk factors;
calculating by the computing system a remainder value by comparing the estimated change in liability value to the actual change in liability value; and
reporting the changes in the liability valuation with respect to each of the one or more risk factors and the remainder value;
whereby the change in liability valuation is allocated to one or more partial sensitivities and a remainder.

2. The method of claim 1 further comprising, prior to the reporting step, the steps of:
identifying at least one changed policyholder including in hedge program;
performing sequential analysis by the computer system on the at least one changed policyholder to determine the change in liability valuation associated with the at least one changed policyholder;
additionally attributing by the computer system the change in liability valuation due to the at least one changed policyholder.

3. The method of claim 1 further comprising, prior to the reporting step, the steps of:
identifying at least one policyholder added to or removed from the hedge program;
performing sequential analysis by the computer system on the at least one policyholder to determine the change in liability valuation associated with the at least one policyholder;
additionally attributing by the computer system the change in liability valuation due to the at least one policyholder.

4. The method of claim 1 wherein the mathematical expansion of the valuation model is a Taylor expansion.

5. The method of claim 1 wherein the one or more risk factors comprise time, account valve and interest rates.

6. The method of claim 1 wherein calculating one or more partial sensitivities of the mathematical expansion to the valuation model comprises changing one risk factor constant at a time while holding the other risk factors constant.

7. The method of claim 1 wherein comparing the estimated change in liability value to the actual change in liability value comprises subtracting the estimated change in liability from the actual change in liability value.

8. The method of claim 1 wherein each of the one or more partial sensitivities is associated with one of the Greeks.

9. A system for attributing a change in liability valuation for a hedge program to one or more risk factors associated with a valuation model for the hedge program comprising:
a computer memory containing a mathematical expansion of the valuation model associated with the hedge program for each risk factors associated with the valuation model;
a computing system in electronic communication with the computer memory for calculating one or more partial sensitivities of the mathematical expansion to the valuation model;
an input interface for receiving market data for each of the risk factors;
a computing system for allocating the change in liability valuation to the one or more partial sensitivities by applying the changes in risk factors, obtained from the input interface, to the partial sensitivities;
a computing system for calculating the estimated change in liability valuation using the partial sensitivities and the changes in risk factors;
a computing system for calculating a remainder value by comparing the estimated change in liability value to the actual change in liability value; and
an output interface for reporting the changes in the liability valuation with respect to each of the one or more risk factors and the remainder value;
whereby the change in liability valuation is allocated to one or more partial sensitivities and a remainder.
